(19) United States
(12) Patent Application Publication
(10) Pub. No.: US 2011/0106353 A1
(43) Pub. Date: May 5, 2011

(54) METHOD AND DEVICE FOR OPERATING A VEHICLE HAVING A HYBRID DRIVE

(76) Inventors: Ernst Brocke, Nuertingen (DE); Robert Lock, Weil Der Stadt (DE); Markus Ganswind, Markgroeningen (DE); Herbert Prickarz, Fellbach (DE)

(21) Appl. No.: 12/736,041

(22) PCT Filed: Nov. 25, 2008
(86) PCT No.: PCT/EP2008/066128

§ 371 Date: Dec. 23, 2010

(30) Foreign Application Priority Data
Mar. 10, 2008 (DE) 10 2008 000 577.0

(51) Int. Cl. G05G 5/03; B60K 6/48; G06F 17/00

(52) U.S. Cl. 701/22; 180/65.25; 180/65.275; 903/902

(57) ABSTRACT

A method for operating a vehicle having a hybrid drive, which vehicle is driven by a first drive unit implemented as internal combustion engine, and a second drive unit, which may be an electric motor, the first drive unit and the second drive unit contributing to the drive of the vehicle individually or jointly. In a method for operating a vehicle having a hybrid drive, in which the driver is informed about the connection of the different drive units, haptic feedback is provided to the driver when the previously idle drive unit is connected to the drive unit that is in operation.

### FIELD OF THE INVENTION

The present invention relates to a method for operating a vehicle having a hybrid drive, which is driven by a first drive unit implemented as internal combustion engine, and a second drive unit, which may be an electric motor, the first drive unit and the second drive unit contributing to the drive of the hybrid vehicle individually or jointly; in addition, the present invention relates to a device for implementing the method.

### BACKGROUND INFORMATION

More and more vehicles are being developed with hybrid drives in which different drives are utilized for a driving task. The individual motors in the hybrid drive can cooperate in various ways. Either they act on the vehicle to be moved at the same time, or only one drive unit acts on the vehicle. The coordination of the drive units is implemented via an engine control, which decides whether to connect or disconnect the various drive units as a function of the operating conditions of the vehicle and the driver input.

### SUMMARY OF THE INVENTION

The exemplary embodiments and/or exemplary methods of the present invention is based on the objective of providing a method for operating a vehicle having a hybrid drive, in which the driver is informed about the connection or disconnection of the different drive units.

The advantage of the haptic feedback to the driver, which takes place when the previously idle drive unit is connected to the drive unit already in operation, is that the driver is informed as to which drive unit is in operation in an uncomplicated manner, without his attention being distracted from the general driving situation. The driver is able to understand rapidly and easily when the individual other drive is connected in order to generate torque. As a result, the driver is given greater control over the vehicle.

Especially rapid haptic feedback is given to the driver when it is provided by way of an accelerator pedal by which a driver-desired torque is input. Additional sources of information for the driver may be dispensed with.

Thus, the accelerator pedal performs two tasks: for one, it transmits the driver-desired speed to an engine control and for another, the accelerator pedal serves as source of information. The driver senses with his foot that a second drive unit has been connected. This information may be provided by the vibration of the accelerator pedal.

In one advantageous development, the haptic feedback takes place via a pressure point in the pedal travel of the accelerator pedal. When actuating the accelerator pedal, the driver feels resistance, which interferes with the normal, e.g., linear, movement characteristic during operation of the accelerator pedal. This provides the desired information about the connection of a further drive unit to the driver.

The pressure point is able to be calculated by an engine control as a function of operating data of the hybrid vehicle such as the charge state of the battery of the electric motor, the requested torque, and also the driver-desired torque. The pressure point is variable as a function of these data. Using this variable pressure point, the driver obtains the information as to when the internal combustion engine or the electric motor is connected. This also takes situations into account in which the internal combustion engine is started up involuntarily, even when this is not required based on the driver input, but the startup instead is necessary because of the drop in the battery output of the electric motor, so that the driving performance is able to be maintained once it has been achieved, or to the operability can be ensured.

In a further development of the exemplary embodiments and/or exemplary methods of the present invention, the pedal travel is subdivided into two ranges by at least one pressure point, the ranges differing from each other by the resistance the accelerator pedal offers to the driver. In a range in which the vehicle is driven only by an electric motor, for example, the accelerator pedal is easier to operate than is the case after the pressure point that signals the connection of the internal combustion engine has been overcome. In this second range the accelerator pedal offers more resistance, which means that the driver has to exert more force in order to depress the accelerator pedal.

During operation of the internal combustion engine, the engine control cancels the pressure point if the second drive unit cannot be connected due to an operating strategy. When using an electric motor as second drive unit, this first occurs when the battery charge state is insufficient, for example, so that the electric motor is unable to be used for increasing the overall output. At low temperatures, too, the battery of the electric motor is not as efficient. The same applies when purely electrical driving with the aid of the electric motor is impossible due to the battery state.

The connection of a drive unit is advantageously indicated optically and/or acoustically. An optical or acoustical signal increases the information content and the reliability of the driver information.

In another further development of the exemplary embodiments and/or exemplary methods of the present invention, a device for operating a vehicle having a hybrid drive, which is driven by a first drive unit implemented as internal combustion engine and by a second drive unit, which may be an electric motor, the first drive unit and the second drive unit contributing to the drive of the vehicle individually or jointly, is provided with an arrangement for outputting haptic feedback to the driver when the previously idle drive unit is connected to the drive unit that is in operation. This measure informs the driver about the connection or disconnection of the drive units.

The information is provided especially rapidly if the haptic feedback takes place via an accelerator pedal that inputs the driver-desired torque.

In an advantageous manner, the accelerator pedal outputs the haptic feedback via a pressure point in the pedal travel. The feedback is implemented in a particularly simple manner if the pressure point is formed by resistance in the pedal travel. In another development, the pressure point subdivides the pedal travel of the accelerator pedal into two ranges, which differ in the resistance offered by the accelerator pedal.

The exemplary embodiments and/or exemplary methods of the present invention permits numerous specific embodiments. One of these is to be explained in greater detail with reference to the figures shown in the drawing.

### BRIEF DESCRIPTION OF THE DRAWINGS

FIG. 1 shows a power-time diagram during operation using the electric motor and the connection of the internal combustion engine.

FIG. 2 shows a power-time diagram during operation of the internal combustion engine and the connection of the electric motor.

FIG. 3 shows realization options of the haptic accelerator-pedal characteristic.

FIG. 4 shows a specific development of a hybrid drive of a vehicle.

### DETAILED DESCRIPTION

In the following examples, an internal combustion engine and an electric motor are considered as drive units of the vehicle.

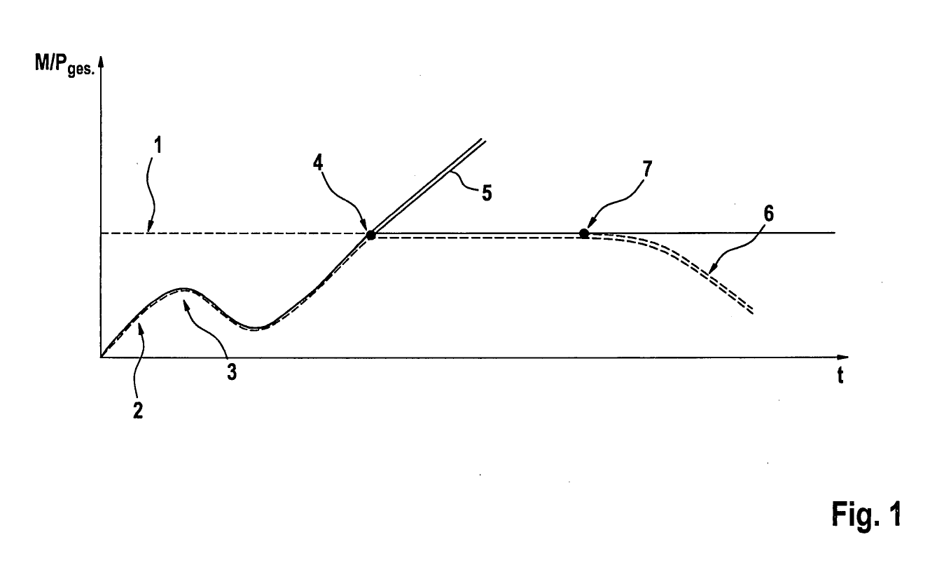

The response of a hybrid drive is to be described in greater detail with the aid of FIG. 1. Initially, the vehicle is operated using the electric motor. Torque request M or the overall output P_{ges} is shown over time t. A dashed line 1 which extends parallel to time axis t documents the maximum output of the electric motor. A solid curve 2 describes the driver-desired torque, which the driver of the vehicle inputs by actuating an accelerator pedal. Dashed curve 3 extending near solid curve 2 for the driver-desired torque describes the actual torque of the electric motor.

As can be gathered from FIG. 1, the driver-desired torque is first generated only by the electric motor. The actual torque of the electric motor has a characteristic that is equivalent to the driver-desired torque. The response time of the electric motor to the driver input is very rapid, which is why both curves 2 and 3 show a very similar characteristic. Pressure point 4 lies at the intersection of the driver-desired torque and dashed line 1, which represents the maximum output of the electric motor. This pressure point 4 is generated by an engine control device, which detects the driver-desired torque documented by the accelerator pedal. Since the output of the electric motor is no longer sufficient for satisfying the driver input at this point, the engine-control device must connect the internal combustion engine. The driver is informed about this situation via pressure point 4, which the engine control device outputs to the accelerator pedal. The connection of the internal combustion engine is shown in FIG. 1 by a solid line 5.

At the point of pressure point 4, the driver feels resistance as information about the fact that the internal combustion engine is now being connected in order to achieve an overall output P_{ges} that lies above the maximum output of the electric motor. However, if the instantaneous torque amounting to the maximum output of the electric motor is sufficient for the driver, as shown in FIG. 1, or if his requested torque remains below or at the level of pressure point 4, the car will be operated by the electric machine alone.

In purely electric driving, however, the battery output drops over time, which causes the output of the electric motor to drop, which is shown in segment 6. Therefore, the operating strategy of the engine control device provides that following a specified time interval, in which the vehicle is driven only via the electric motor, the internal combustion engine is forced to start up (point 7) in order to compensate for the drop in the maximum output of the electric motor and to be able to maintain the driver-desired torque accordingly.

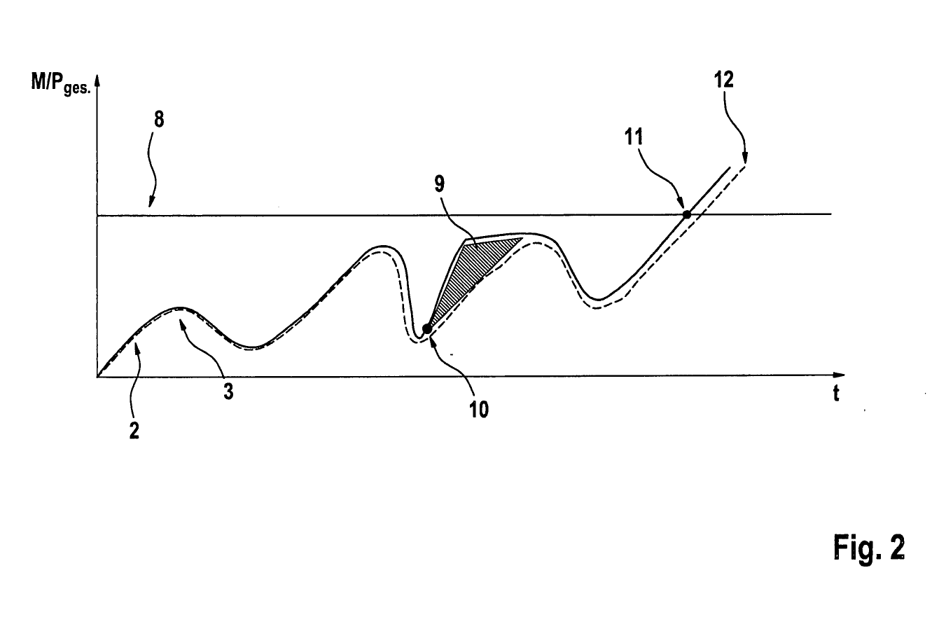

FIG. 2 likewise shows a performance-time diagram in which the vehicle is driven by an internal combustion engine. Here, too, the driver input is shown by a solid curve 2, while the actual torque of the internal combustion engine is shown by a dashed curve 3. The maximum output of the internal combustion engine is shown by solid horizontal line 8.

In the beginning, curve 2, which represents the driver-desired torque, and curve 3, which represents the actual torque of the internal combustion engine, have virtually the same characteristic. In this phase the driver depresses the accelerator only slowly, and the internal combustion engine is able to follow the torque requested by the driver without any problems.

However, if the driver actuates the accelerator more rapidly, then the internal combustion engine cannot supply the actual torque with regard to the driver-desired torque to the desired extent. Curve 2 and curve 3 diverge due to the lag of the combustion engine. When the accelerator is depressed very rapidly, the internal combustion engine is unable to follow.

The engine control device connects the electric motor in range 9 in order to compensate for the non-steady state, until the actual torque of the internal combustion engine once again approaches the driver-desired torque.

Via pressure point 10, the engine control device informs the driver that the electric motor is connected.

If the driver-desired torque has achieved the maximum output of the internal combustion engine, it will be signaled to the driver via a further pressure point 11 that the electric motor is being connected in order to generate an additional torque to satisfy the driver input, which is documented by a second solid line 12.

If the driver-desired torque remains below pressure point 11, the car continues to be driven solely by the internal combustion engine.

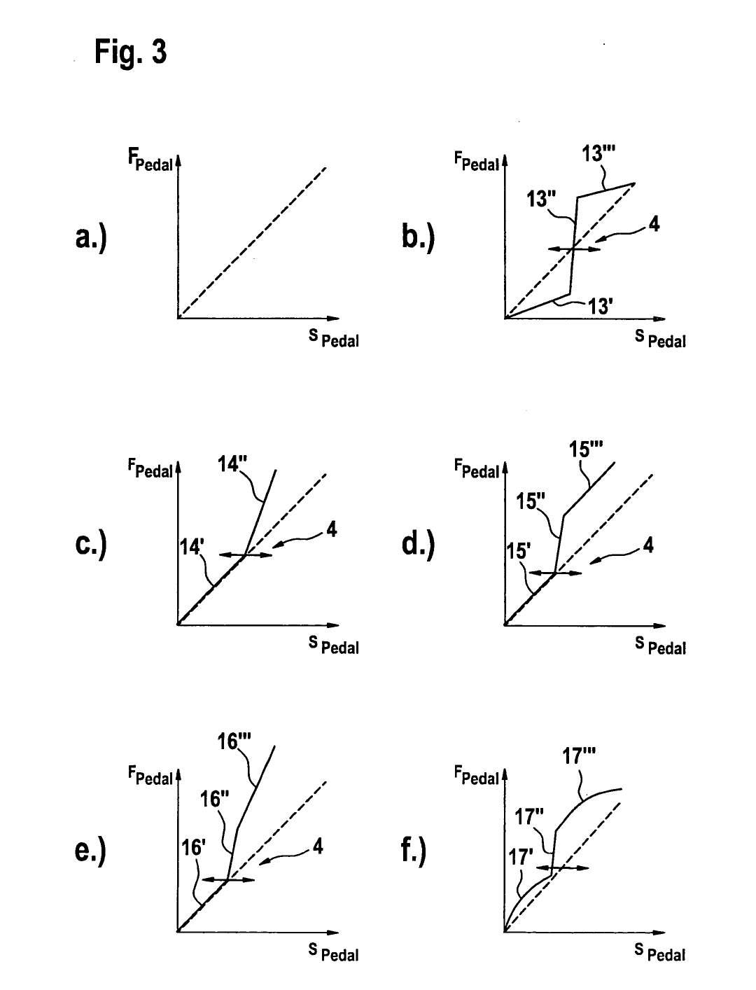

Various realization options for the haptic accelerator characteristic may be gathered from FIG. 3. In this context, force F_{pedal} required to move the accelerator is shown over pedal travel S_{pedal}. Illustration a) shows the dependency for an accelerator in a conventional vehicle. In the selected example, there is a linear correlation between force F_{pedal} and travel s_{pedal} covered at this force, which means that given a constant force, the same travel is covered at all times.

Illustration b) shows a pressure point 4, which is able to be shifted as a function of the available engine torque or the overall output. In first segment 13′ and in third segment 13′″ of the solid curve, a constant force, which is lower than in a conventional vehicle (dashed line), is used for a predefined pedal travel. In second segment 13″, a relatively high force must be used for a short pedal travel. This point appears to the driver as pressure point 4 and signals the connection of a drive unit to him in the manner already explained. At which point of the pedal travel this pressure point 4 is set depends on the operating strategy of the engine control device and is therefore variable. Once pressure point 4 has been overcome, the pedal is able to be moved more easily again in segment 13′″.

Another option is shown in illustration c). In a specified first segment 14′, force F_{pedal} required for a specific travel S_{pedal} progresses in linear manner. In following segment 14″, greater force than in first segment 14′ must be exerted for the travel. This force is easily set via the resistance of the accelerator pedal. In first segment 14′, the accelerator is easy to operate, whereas greater force is required for moving it in segment section 14″. Pressure point 4 is the point at which the transition occurs from light resistance to great resistance.

Illustration d) shows another example, in which the pedal movability is subdivided into three segments. At increasing force F_{Pedal}, a specific travel S_{Pedal} is covered in first segment 15′. In second segment 15″, greater force F_{Pedal} is required to cover a short pedal travel S_{Pedal}, whereas force F_{Pedal} for overcoming travel S_{Pedal} becomes lower again in third segment′″ and lies in the same order of magnitude as in first segment 15′.

Three different forces F_{Pedal} must be generated in the three segments of illustration e). Lowest force F_{Pedal} is required in first segment 16′ for overcoming a relatively long pedal travel S_{Pedal}. On the other hand, greatest force F_{Pedal} is required for a relatively short travel S_{Pedal} in segment 16″, which characterizes pressure point 4. A force F_{Pedal}, whose value lies between the forces described in segments 16′ and 16″, is exerted in segment 16″′. In this development, in particular, it is also possible to realize two pressure points, which, for example, represent the non-steady-state compensation of the electric motor in the first pressure point, for example, and the connection of the electric motor to the internal combustion engine in the second pressure point, as described in connection with FIG. 2.

In the three segments of illustration f) as well, different forces F_{Pedal} must be generated in order to overcome three pedal travels S_{Pedal}. In first segment 17′, the force application is non-linear relative to travel S_{Pedal}. In order to overcome the travel, slightly more force F_{Pedal} must be applied initially and then slightly less F_{Pedal} force subsequently. In segment 17″, a constant, high force F_{Pedal} is necessary to cover a short travel S_{Pedal}. Analogously to segment 17′, different forces are necessary in segment′″ in order to cover desired pedal travel S_{Pedal}.

The horizontal arrow in illustrations 3b through 3f indicates the battery power of the electric motor, which may change several times during a ride, so that pressure point 4 shifts accordingly.

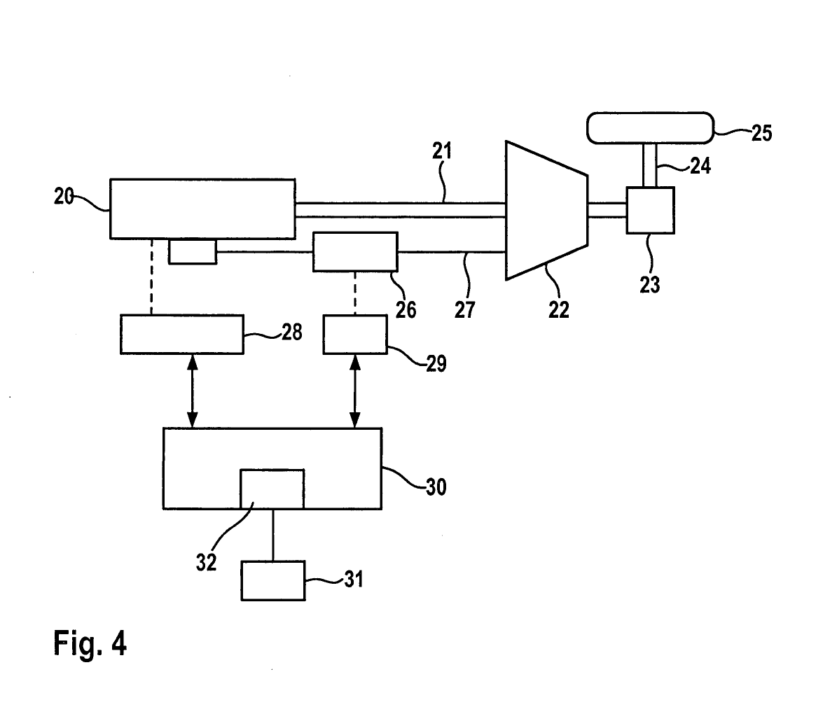

FIG. 4 shows one potential development of a hybrid drive of a vehicle by which the method described in the introduction is able to be implemented. This hybrid drive has an internal combustion engine 20 as a first drive unit. Internal combustion engine 20 is connected to a transmission 22 via a drive train 21. Transmission 22 in turn leads to a differential gear 23, which is connected to wheel 25 via vehicle axle 24 and transmits the power generated by internal combustion engine 20 to wheel 25.

An electric motor 26 is provided as second drive unit in the indicated example. Electric motor 26 has its own drive train 27, via which it is connected to transmission 22.

Transmission 22 transmits the power supplied by electric motor 26 to wheel 25 via differential 23 and wheel axle 24.

The control and regulation of internal combustion engine 20 takes place via engine-control device 28, and the control and regulation of electric motor 26 is implemented via control device 29 of the electric motor. Engine control device 28 and electric motor control device 29 communicate with accelerator pedal electronics 30, which are connected to accelerator pedal 31. Accelerator pedal electronics 30 convert the signals emitted by engine control device 28 and electric motor control device 29 into mechanical states, such as pressure point and stiffness of accelerator pedal 31, via an electro-mechanical converter 32 provided therein.

1-14. (canceled)

15. A method for operating a vehicle having a hybrid drive, which includes a first drive unit implemented as internal combustion engine and a second drive unit, the first drive unit and the second drive unit contributing to the drive of the vehicle individually or jointly, the method comprising:
when a previously idle one of the drive units is connected to the other one of the drive units being operated, providing a driver with haptic feedback.

16. The method of claim 15, wherein the haptic feedback takes place via an accelerator pedal, by which a driver-desired torque is input.

17. The method of claim 16, wherein the haptic feedback takes place via a pressure point in the pedal travel of the accelerator pedal.

18. The method of claim 17, wherein the pressure point is formed by resistance in the pedal travel.

19. The method of claim 17, wherein the pressure point is calculated as a function of operating data of the hybrid vehicle.

20. The method of claim 17, wherein the pressure point is calculated as a function of the driver-desired torque.

21. The method of claim 17, wherein the pedal travel is subdivided by at least one pressure point into two segments, which differ by a resistance of the accelerator pedal.

22. The method of claim 17, wherein when operating the first drive unit, the pressure point is canceled if the connection of the second drive unit is not possible due to an operating strategy.

23. The method of claim 15, wherein the connection of one of the drive units is indicated at least one of optically and acoustically.

24. The method of claim 15, wherein the second drive unit is implemented as an electric motor.

25. A device for operating a vehicle having a hybrid drive, which is driven by a first drive unit implemented as internal combustion engine, and a second drive unit, the first drive unit and the second drive unit contributing to the drive of the vehicle individually or jointly, comprising:
a haptic feedback arrangement to output haptic feedback to a driver when a previously idle one of the drive units is connected to the other one of the drive units that is being operated.

26. The device of claim 25, wherein the haptic feedback takes place via an accelerator pedal that inputs the driver-desired torque.

27. The device of claim 26, wherein the accelerator pedal outputs the haptic feedback via a pressure point in the pedal travel.

28. The device of claim 27, wherein the accelerator pedal forms the pressure point by resistance in the pedal travel.

29. The device of claim 27, wherein the pedal travel of the accelerator pedal is subdivided by the pressure point into two segments, which differ in the resistance of the accelerator pedal.

30. The device of claim 25, wherein the second drive unit is implemented as an electric motor.
